(19) United States
(12) Patent Application Publication
(10) Pub. No.: US 2013/0309913 A1
(43) Pub. Date: Nov. 21, 2013

(54) Connector and Assembly Jig for Connector

(71) Applicant: Tomohiko Shimizu, Makinohara-shi (JP)

(72) Inventor: Tomohiko Shimizu, Makinohara-shi (JP)

(73) Assignee: YAZAKI CORPORATION, Minato-ku, Tokyo (JP)

(21) Appl. No.: 13/982,976

(22) PCT Filed: Feb. 10, 2012
(86) PCT No.: PCT/JP2012/053171

§ 371 Date: Jul. 31, 2013

(30) Foreign Application Priority Data
Feb. 18, 2011 (JP) 2011-033711

(51) Int. Cl. H01R 13/405; H01R 43/26

(52) U.S. Cl. CPC H01R 13/405; H01R 43/26
USPC 439/660; 29/747

(57) ABSTRACT

A joint connector includes connector housing 30 in which a plurality of terminal accommodation compartments are arranged in line within a horizontal plane, a plurality of pieces of female terminal fitting inserted into the respective terminal accommodation compartments from behind, and flexible lances that are provided in the respective terminal accommodation compartments and that retain the pieces of female terminal fitting inserted into the respective terminal accommodation compartments from behind. All of the lances provided in the respective terminal accommodation compartments are joined integrally by means of a horizontally-stretched connecting member 17. The connecting member is provided with operation sections 18 that concurrently bend all of the lances when the connecting member is operated.

### TECHNICAL FIELD

The present invention relates to a joint connector in which a plurality of pieces of female terminal fitting are conductively connected to each other by a joint terminal.

### BACKGROUND ART

FIG. 8 shows an example of an existing joint connector.

A joint connector 100 is disclosed in Patent Document 1 to be described below and outfitted with a joint terminal (a bus bar) 110, a plurality of pieces of female terminal fitting 120, a first connector housing 130, and a second connector housing 140.

The joint terminal 110 is a press molded metal article that has a plurality of tab pieces 111 to be fit-connected to the respective pieces of female terminal fitting 120 and a joining section 112 that conductively interconnects the tab pieces 111.

The female terminal fitting 120 includes rectangular-tube-like boxes 121 that are articles formed from a metal plate by press molding and into which the tab pieces 111 are to be fitted, electric cable caulking sections 122 that extend from rear ends of the respective boxes 121 and that crimp respective electric cables 150, and latch recesses 123 for retaining purpose.

The first connector housing 130 has one housing end 131 that is an article formed from a resin by injection molding and a tube-shaped hood 132 that extends from the one housing end 131.

The one housing end 131 accommodates and retains the joint terminal 110 while the tab pieces 111 are oriented toward another end 130a (a right end in FIG. 8) of the housing. The one housing end 131 retains the joint terminal 110 by means of; for instance, insert molding.

The hood 132 is a tube-shaped section that permits fitting of the second connector housing 140. Lock holes 134 used for locking the thus-fitted second connector housing 140 are formed in the hood 132.

The second connector housing 140 accommodates and retains the female terminal fitting 120 and is fit-connected to the first connector housing 130.

The second connector housing 140 has a plurality of female terminal accommodation holes 141 for accommodating the pieces of female terminal fitting 120, lances 142 for retaining the pieces of female terminal fitting 120 inserted in the respective female terminal accommodation holes 141, and lock projections 143 for locking a state in which the second connector housing is joined to the first connector housing 130.

Each of the lances 142 has a terminal latch projection 142b that protrudes toward the corresponding female terminal accommodation hole 141 and is provided at a free end side of a resilient piece 142a stretching along a corresponding female terminal accommodation hole 141. In each of the lances 142, during the course of the female terminal fitting 120 being inserted into the corresponding female terminal accommodation hole 141, the resilient piece 142a becomes resiliently deformed by means of interference between the box 121 of the female terminal fitting 120 and the corresponding terminal latch projection 142b in such a way that the terminal latch projection 142b becomes bent outside the female terminal accommodation hole 141, thereby permitting insertion of the female terminal fitting 120. When the pieces of the female terminal fitting 120 are inserted up to respective specified positions, the terminal latch projections 142b are engaged with the latch recesses 123 of the respective pieces of the female terminal fitting 120 by dint of resilient restoration force of the respective terminal latch projections 142b, thereby retaining the respective pieces of the female terminal fitting 120.

When the first connector housing 130 and the second connector housing 140 have finished normally fitting together, the lock projections 143 are engaged with the respective lock holes 134 of the first connector housing 130, thereby locking the connector housings in a mutually engaged state.

In the foregoing joint connector 100, a half fitted state detection projection 135 is provided on the one housing end 131 of the first connector housing 130 as half fitted state detection means for detecting a half fitted state (an incomplete inserted state) in which the respective pieces of the female terminal fitting 120 provided on the second connector housing 140 have not yet reached their respective specified positions.

The half fitted state detection projection 135 is a projection that is inserted into a shelter space 145 of each of the lances 142 when the first connector housing 130 and the second connector housing 140 are fitted into each other. In a half fitted state in which the respective pieces of the female terminal fitting 120 are not fully fitted into the respective female terminal accommodation holes 141, the lances 142 are resiliently deformed toward the respective shelter spaces 145. Accordingly, when the housings are fitted into each other, the half fitted state detection projection 135 interferes with leading ends of the respective lances 142 that remain deformed toward the respective shelter spaces 145, thereby hindering mutual-fitting of the housings. The half fitted state of the female terminal fitting 120 is thereby detected.

incidentally, when the female terminal fitting 120 is in numbers, work for inserting the pieces of female terminal fitting 120 into the respective terminal accommodation holes 141 while holding the lances 142 bent with the female terminal fitting 120 must be carried out while exerting insertion forces enough to bend the lances 142 on the respective lances 142, and hence is burdensome.

A connector 200 has therefore been proposed as shown in FIG. 9 (see Patent Document 2). Namely, a holder 201 is outfitted to a connector housing 202, and a plurality of lances 203 are bent at a time by means of the holder 201. All pieces of female terminal fitting 205 are inserted into respective terminal accommodation holes 204 in this state. After insertion of the terminal fitting, the holder 201 is removed, thereby restoring all of the lances 203 from the bent state. The pieces of female terminal fitting 205 are engaged with the respective lances 203.

### RELATED ART DOCUMENTS

### Patent Documents

Patent Document 1: JP-A-8-250185
Patent Document 2: JP-A-9-35800

### SUMMARY OF THE INVENTION

### Problem that the Invention is to Solve

The connector 200 in which all of the lances 203 are bent by attaching the holder 201 to the connector housing 202, however, encounters a problem of an increase in the number of components because the holder 201 is an indispensable component. Moreover, since the holder 201 must be engaged with all of the lances 203, outfitting the holder 201 requires attention. In addition, the lances 203 in the connector housing 202 return from the bent state after removal of the holder 201, to thereby individually engage with the respective pieces of female terminal fitting 205. Accordingly, even when the female terminal fitting 205 is in a half fitted state, it is difficult for the worker to realize it. Moreover, fixing force (holding force) of the female terminal fitting 205 is determined by the strength of the individual lances 203. Therefore, there is a limitation on enhancement of the holding force of the female terminal fitting 205.

Consequently, an objective of the present invention is to solve the problem and provide a joint connector that enables a reduction in force required to insert a terminal, a decrease in the number of components, facilitation of terminal assembly work and detection of a half inserted state of a terminal, and enhancement of terminal holding power and an assembly jig that is used when the terminal is inserted into a housing of the joint connector.

### Means for Solving the Problem

The objective of the present invention is accomplished by the following configurations.

(1) A joint connector comprising:

a plurality of pieces of female terminal fitting;

a joint terminal having a plurality of tab pieces that are to be fit-connected to the respective pieces of female terminal fitting and a joining section that conductively interconnects the tab pieces; and

a connector housing that is made from a resin and that has one housing end which accommodates and retains the joint terminal with the tab pieces oriented toward another housing end, the other housing end in which female terminal accommodation holes that fit the tab pieces into the respective pieces of female terminal fitting by inserting the female terminal fitting up to a specified position are arranged in line within a horizontal plane orthogonal to a longitudinal direction, and lances for retaining the female terminal fitting inserted to the specified positions in the respective female terminal accommodation holes, wherein

the lances are provided for the respective terminal accommodation holes, and all of the lances are integrally joined together by means of a horizontally-stretched connecting member; and

the connecting member is provided with operation sections that integrally bend the lances in a direction in which removal of the female terminal fitting is prevented by operation of the connecting member.

(2) In the joint connector defined in (1), the operation sections are provided at respective lateral ends of the connecting member, and the lateral operation sections protrude outward from both lateral ends of a main body of the connector housing.

(3) An assembly jig for connector used when the female terminal fitting is attached to the connector housing defined in (2) comprising:

an insert recess used for insertion of the connector housing, and engagement sections that are provided in a periphery of the insert recess and that interfere with the lateral operation sections of the connecting member when the connector housing is inserted into the insert recess, thereby operating the connecting member and bending all of the lances in a direction in which removal of the pieces of female terminal fitting is avoided.

In the joint connector having the configuration defined in (1), all of the lances provided for the respective terminal accommodation holes are integrally joined by means of the horizontally-stretched connecting member. Since the connecting member is provided with the operation sections that concurrently bend all of the lances by operation of the connecting member, all of the lances can be concurrently bent by operation of the operation sections. All of the pieces of female terminal fitting can be inserted, in that state, into the terminal accommodation compartments of the connector housing. Further, when the operation sections are released while all of the pieces of female terminal fitting are inserted, all of the lances return from their bent state, engaging with the respective pieces of female terminal fitting. Hence, the respective pieces of female terminal fitting can be retained. Moreover, even when the female terminal fitting is removed from the connector housing, all of the lances can be bent concurrently, so that all of the pieces of female terminal fitting can be pulled out.

Since the female terminal fitting can be inserted while the lances remain previously bent as above, forces required to insert the female terminal fitting can be lessened. Moreover, since the lances themselves are integrally joined together, a retaining tool for bending all of the lances in unison is not necessary, so that the number of components can be curtailed. Furthermore, since all of the lances are integrally joined together, rigidity of the lances can be enhanced, and holding power exerted on the female terminal fitting can thereby be enhanced. When any one of the terminals is in a half inserted state, the lance corresponding to the piece of female terminal fitting remaining in a half inserted state will not return to its home position from the bent state. Accordingly, not all of the lances and the connecting member will return to their initial positions, which lets the worker easily understand the half inserted state of the piece of female terminal fitting.

In relation to the connector having the configuration defined in (1), the female terminal fitting can be fitted to a joint member when the respective pieces of female terminal fitting are inserted into the respective terminal accommodation compartments while the joint member remains previously accommodated in the connector housing. Therefore, the terminals can be tentatively engaged even when the lances remain bent.

In relation to the connector having the configuration defined in (2), since the operation sections are provided on both lateral ends of the connecting member, all of the lances can be bent in a well balanced manner, so that facilitating insertion of the female terminal fitting can be smoothly realized.

In relation to the assembly jig having the configuration defined in (3), all of the lances can be bent in a direction in which removal of the female terminal fitting is avoided by means of only inserting the connector housing into the insert recess of the assembly jig. Therefore, removal and insertion of all of the pieces of female terminal fitting can be performed.

The present invention enables lessening of forces required to insert the female terminal fitting, a reduction the number of components, facilitation of work for assembling female terminal fitting, facilitation of detection of a half inserted state of female terminal fitting, and enhancement of holding power exerted on female terminal fitting.

### BRIEF DESCRIPTION OF THE DRAWINGS

FIG. 1 is an exploded perspective view of a joint connector that serves as a connector of an embodiment of the present invention.

FIG. 2 is a perspective view of an inverted connector housing of the joint connector shown in FIG. 1.

FIG. 3 is a cross sectional view observed in arrowy directions III-III shown in FIG. 2.

FIG. 4 is a perspective view showing a configuration of a terminal used in the joint connector shown in FIG. 1.

FIG. 5 is a perspective view showing that the joint connector shown in FIG. 1 is in the middle of being attached to an assembly jig.

FIG. 6 is a perspective view showing that all lances are bent as a result of the joint connector shown in FIG. 1 being attached to the assembly jig and an enlarged view of a principal section of the assembly jig.

FIG. 7(a) to FIG. 7(c) are explanatory views of procedures for assembling the joint connector shown in FIG. 1, wherein FIG. 7(a) is a side view showing that attaching the joint connector to the assembly jig is started, FIG. 7(b) is a side view showing that all of the lances are bent by attaching the joint connector to the assembly jig, and FIG. 7(c) is a side cross sectional view showing that the lances are engaged with terminals after having returned from the bent state by pulling the connector housing out of the assembly jig after insertion of all terminals.

FIG. 8 is a longitudinal cross sectional view showing an exploded state of a related art joint connector.

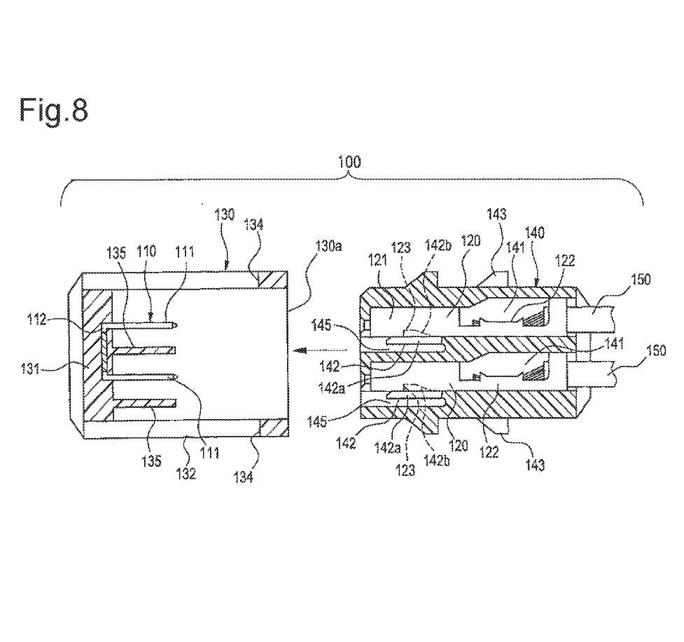

FIG. 9 is a side cross sectional view showing a configuration of a related art connector.

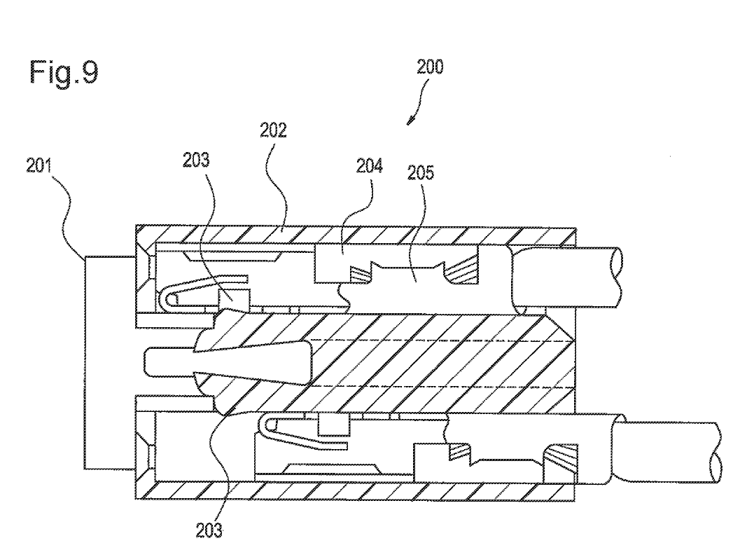

### EMBODIMENT FOR IMPLEMENTING THE INVENTION

An embodiment of the present invention is hereunder described by reference to the drawings.

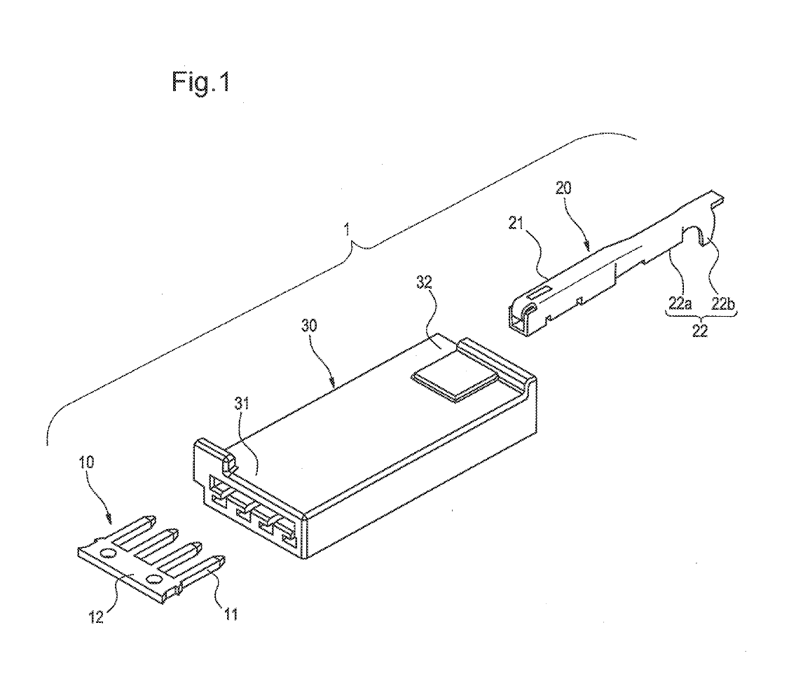

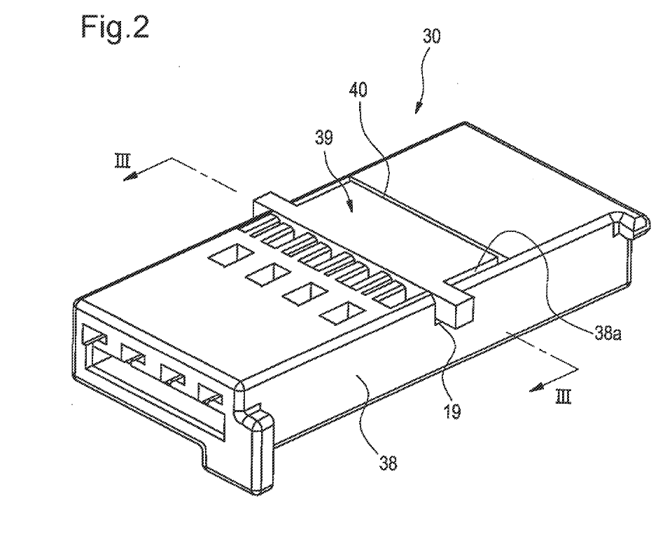

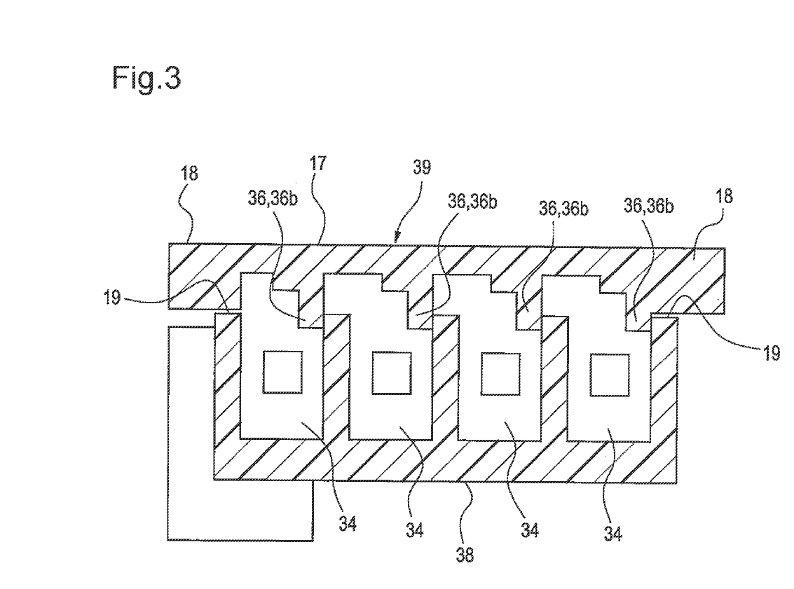

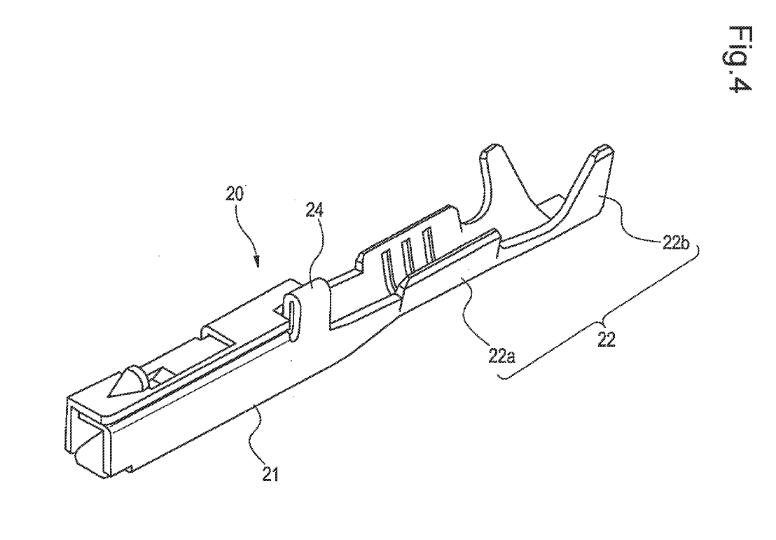

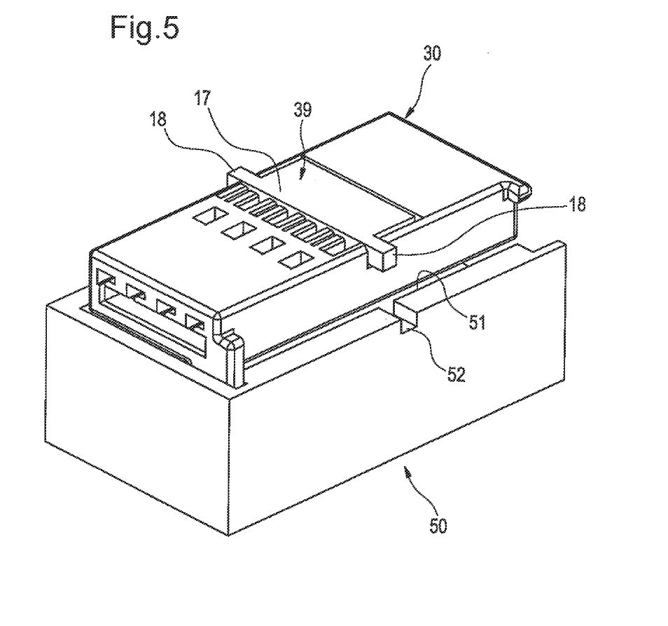

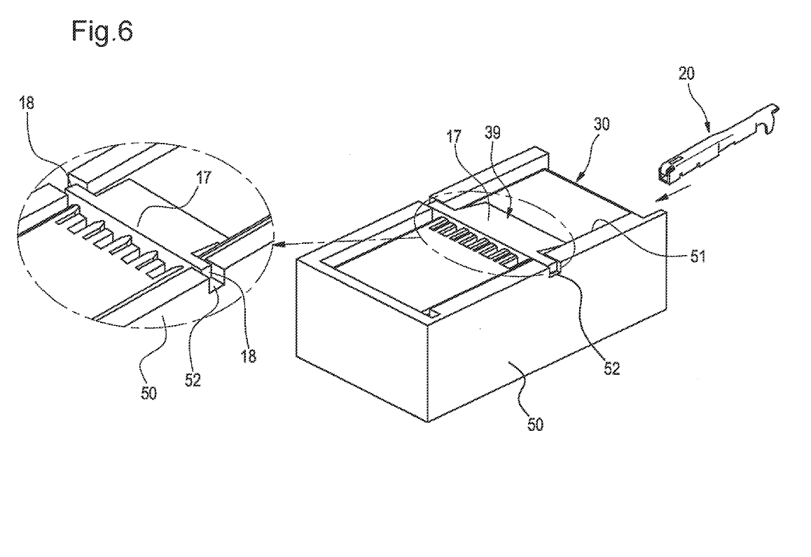

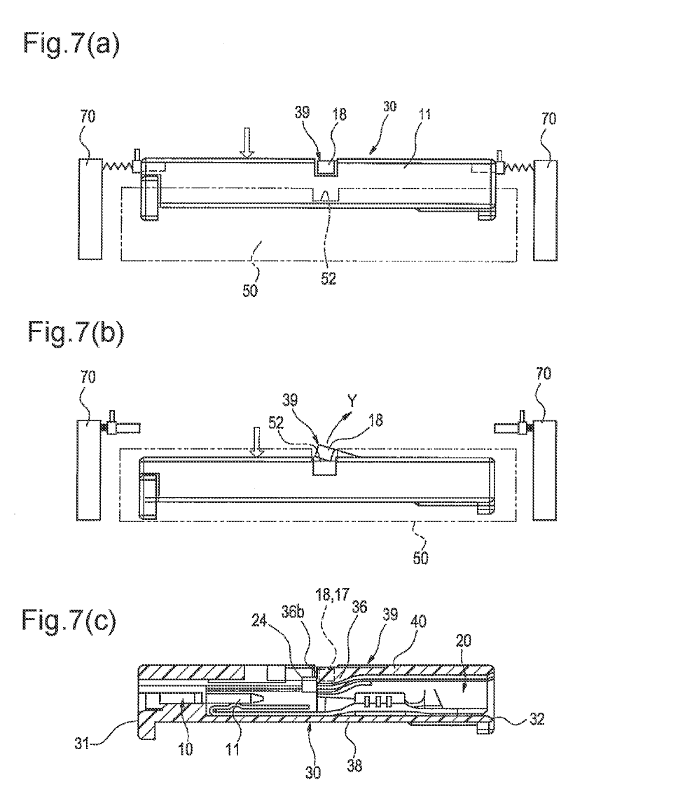

FIG. 1 is an exploded perspective view of a joint connector of an embodiment of the present invention. FIG. 2 is a perspective view of an inverted connector housing of the joint connector shown in FIG. 1. FIG. 3 is a cross sectional view observed in arrowy directions III-III shown in FIG. 2. FIG. 4 is a perspective view showing a configuration of female terminal fitting used in the joint connector shown in FIG. 1. FIG. 5 is a perspective view showing that the joint connector shown in FIG. 1 is in the middle of being attached to an assembly jig. FIG. 6 is a perspective view showing that all lances are bent as a result of the joint connector shown in FIG. 1 being attached to the assembly jig and an enlarged view of a principal section of the assembly jig. FIG. 7(a) to FIG. 7(c) are explanatory views of procedures for assembling the joint connector shown in FIG. 1, wherein FIG. 7(a) is a side view showing that attaching the joint connector to the assembly jig is started, FIG. 7(b) is a side view showing that all of the lances are bent by attaching the joint connector to the assembly jig, and FIG. 7(c) is a side cross sectional view showing that the lances are engaged with terminals after having returned from the bent state by pulling the connector housing out of the assembly jig after insertion of all terminals.

As shown in FIG. 1, the joint connector 1 of the embodiment has a joint terminal 10, pieces of female terminal fitting 20, and a connector housing 30 made from a resin.

The joint terminal 10 is a press molded metal article and has a plurality of tab pieces 11 to be fit-connected to the respective pieces of female terminal fitting 20 and a joining section 12 that conductively interconnects the tab pieces 11.

As shown in FIG. 1 and FIG. 4, each of the pieces of female terminal fitting 20 has a rectangular-tube-like box section 21 that is an article formed from a metal plate by press molding and into which the corresponding tab piece 11 fits, an electric cable caulking section 22 that stretches out from a rear end of the box section 21 and crimps an electric cable, and an insertion guide protruding piece 24.

The electric cable caulking section 22 has a conductor caulking piece 22a for crimping a conductor of the electric cable and a sheath caulking piece 22b that is caulked to a sheath of the electric cable, thereby fixing the electric cable.

The insertion guide protruding piece 24 is a tongue-shaped piece that is situated at a position closer to a rear end of the box section 21 and that stretches along a direction in which the insertion guide protruding piece 24 is inserted into a corresponding female terminal accommodation hole 34 of the connector housing 30 to be described later. The insertion guide protruding piece 24 is formed into a shape of a tongue by stretching a portion of a sidewall of the box section 21 and bending the thus-stretched portion. In the embodiment, lances 36 are engaged with the respective insertion guide protruding pieces 24 when the pieces of female terminal fitting 20 are inserted up to a specified position, thereby retaining the pieces of female terminal fitting 20.

The connector housing 30 has a housing main body 38 that is an article formed from a resin by injection molding, one housing end 31, another housing end 32 that is on the other side of the one housing end 31, and a terminal latch plate 39.

As shown in FIG. 7(c), the one housing end 31 accommodates and retains the joint terminal 10 while the tab pieces 11 are oriented toward the other housing end 32.

As shown in FIG. 3, the plurality of female terminal accommodation holes 34 are arranged in line within a horizontal plane that is orthogonal to a longitudinal direction at the other housing end 32. The plurality of female terminal accommodation holes 34 are holes that fit the tab pieces 11 into the corresponding pieces of female terminal fitting 20 as a result of the female terminal fitting 20 is inserted up to a specified position. The expression “specified position” means a location where a contact length which is necessary and sufficient for establishing an electrical connection between the tab pieces 11 and the box section 21 is achieved.

The housing main body has the flexible lances 36 for retaining the female terminal fitting 20 to be inserted into the respective terminal accommodation holes 34 from behind. As shown in FIG. 3, each of the lances 36 has a terminal latch projection 36b.

The terminal latch projections 36b protrude toward the respective female terminal accommodation holes 34 and are engaged with, as shown in FIG. 7(c), the insertion guide protruding piece 24 inserted up to the specified position, thereby retaining the female terminal fitting 20.

The terminal latch plate 39 is a wall-shaped element that has a base end side 40 to be joined to the housing main body 38 and a freely-bendable free end side. The terminal latch plate 39 is molded from a synthetic resin integrally with the housing main body 38 so as to fill an aperture 38a formed in a vertical plate surface of the housing main body 38. The terminal latch plate 39 is formed by integrally joining all of the lances 36 provided in the respective terminal accommodation holes 34 by means of a horizontally stretched connecting member 17. Operation sections 18 are provided on respective ends of the connecting member 17 and bend all of the lances 36 in an integrated fashion by operation of the connecting member 17. The operation sections 18 provided on the respective ends of the connecting member 17 protrude outward from both lateral ends of the housing main body 38. In an initial phase in which the lances 36 are not bent, the operation sections 18 remain fitted in recesses 19 formed in respective sidewalls of the housing main body 38.

It is better to use an assembly jig 50 shown in FIG. 5 to FIG. 7(c) at the time of assembly of the joint connector. The assembly jig 50 is used when the pieces of female terminal fitting 20 are inserted into the respective terminal accommodation compartments 34 of the connector housing 30 and has an insert recess 51 that is intended for insertion of the connector housing 30 and that has an open top and a rectangular shape when viewed from above. Engagement sections 52 are provided in a periphery (an upper edge) of the insert recess 51. When the connector housing 30 is inserted with its back side up into the insert recess 51, the engagement sections 52 interfere with the respective operation sections 18 provided at both lateral ends of the connecting member 17, thereby operating the connecting member 17 and bending all of the lances 36. The engagement sections 52 are provided in the form of recesses into which the operation sections 18 are fitted from above. Moreover, of the sidewalls that make up the insert recess 51, a rear side wall is cut into a required size so as to allow insertion of the pieces of female terminal fitting 20 into the connector housing 10.

A retaining device 70 shown in FIG. 7(a) and FIG. 7(b) is used at the time of assembly of the joint connector of the embodiment. The retaining device 70 is one that is used when the connector housing 30 is inserted into the assembly jig 50, and the retaining device 70 is used for holding and fixing the connector housing 30.

On the occasion of assembly of the joint connector, the joint terminal 10 made up of bus bars is first attached to a front of the connector housing 30. Next, as shown in FIG. 5 and FIG. 6, the connector housing 30 is inserted with its back side up into the insert recess 51 of the assembly jig 50. During insertion, the operation sections 18 provided at the respective ends of the connecting member 17 of the terminal latch plate 39 come into contact with the engagement sections 52 of the periphery of the insert recess 51 of the assembly jig 50, and the terminal latch plate 39 is pushed by the engagement section 52 and thus lifted up as designated by arrow Y shown in FIG. 7(b). On this occasion, all of the lances 36 provided in the respective terminal accommodation compartments 34 are provided integrally with the terminal latch plate 39. Hence, all of the lances 36 are bent in a direction to avoid removal of the pieces of female terminal fitting 20; in other words, a direction in which the lances 36 recede from the respective female terminal accommodation holes 34. This allows insertion of all of the pieces of female terminal fitting 20 into the respective terminal accommodation holes 34 of the connector housing 30.

Accordingly, after insertion of all of the pieces of the female terminal fitting 20, the connector housing 30 is taken out of the assembly jig 50 while being lifted up. Since the interference existing between the operation sections 18 of the terminal latch plate 39 and the engagement sections 52 of the assembly jig 50 is eliminated as a result of the connector housing 30 being taken out of the assembly jig 50, the terminal engagement plate 39 returns to its home position, and all of the lances 36 return from their bent state, engaging with the respective pieces of female terminal fitting 20. Thus, the respective pieces of female terminal fitting 20 are retained.

Since the female terminal fitting 20 can be inserted into the connector housing while the lances 36 remain bent as mentioned above, forces required to insert the female terminal fitting 20 can be lessened. Moreover, since the lances 36 are joined integrally, a retaining tool for concurrently bending all of the lances 36 is not necessary in contradistinction with the related art example, and the number of components can be curtailed. Since all of the lances 36 are joined integrally, the rigidity of the lances 36 can be enhanced, so that holding power exerted on the female terminal fitting 20 can be enhanced. Even when any one of the pieces of female terminal fitting 20 is in a half inserted state, the lance 36 corresponding to the piece of female terminal fitting 20 that still remains in the half inserted state will not return to its home position from the bent state. As a result, not all the lances 36 or a connecting member 14 return to their home positions, which lets the worker easily realize the half inserted state of the piece of female terminal fitting 20.

Further, in the joint connector of the embodiment, the pieces of female terminal fitting 20 are inserted into the respective terminal accommodation compartments 34 while the joint terminal 10 is previously accommodated in the connector housing 30, whereby the female terminal fitting 20 can be fitted to the joint terminal 10. Hence, even when the lances 36 are in a bent state (a disengaged state), the female terminal fitting 20 can be tentatively engaged.

In the joint connector of the embodiment, the operation sections 18 are provided on both lateral ends of the connecting member 17. Hence, all of the lances 36 can be bent in a well-balanced manner, so that insertion of the female terminal fitting 20 can be smoothly realized.

Even when the female terminal fitting 20 is removed from the connector housing 30, all of the lances 36 can be concurrently bent in the same manner as mentioned above by inserting the connector housing 30 into the insertion recess 51 of the assembly jig 50. Hence, all of the pieces of female terminal fitting 20 can be simultaneously pulled out.

As above, all of the lances 36 can be bent by means of only inserting the connector housing 30 into the insertion recess 51 of the assembly jig 50. Insertion and removal of all of the pieces of female terminal fitting 20 become thereby feasible, so that workability is enhanced.

Incidentally, the present invention is not limited to the embodiment and susceptible to alterations, improvements, and the like, as necessary. In addition, the constituent elements described in connection with the embodiment are arbitrary and not restricted in terms of a material, a shape, a dimension, number of elements, locations, and others, so long as the present invention can be accomplished by the elements.

For instance, the embodiment has explained the case where the present invention is applied to the joint connector which interconnects the pieces of female terminal fitting 20 by means of the connecting member 40. However, the present invention can be applied to another connector.

Although the present invention has been described in detail by reference to the specific embodiment, it is manifest to those who are skilled in the art that the present invention be liable to various alterations and modifications without departing the spirit and scope of the present invention.

The patent application is based on Japanese Patent Application (JP-2011-033711) filed on Feb. 18, 2011, the subject matter of which is incorporated herein by reference in its entirety.

### INDUSTRIAL APPLICABILITY

The present invention enables lessening of forces required to insert the female terminal fitting, a reduction in number of components, facilitation of work for assembling female terminal fitting, facilitation of detection of a half inserted state of female terminal fitting, and enhancement of holding power exerted on female terminal fitting.

### DESCRIPTIONS OF THE REFERENCE NUMERALS AND SYMBOLS

10 JOINT MEMBER
17 CONNECTING MEMBER
18 OPERATION SECTION
20 FEMALE TERMINAL FITTING
30 CONNECTOR HOUSING
34 TERMINAL ACCOMMODATION COMPARTMENT
38 HOUSING MAIN BODY
50 ASSEMBLY JIG
51 INSERTION RECESS
52 ENGAGEMENT SECTION

1. A joint connector comprising:
a plurality of pieces of female terminal fittings;
a joint terminal having a plurality of tab pieces that are to be fit-connected to respective pieces of the female terminal fittings and a joining section that conductively interconnects the tab pieces; and
a connector housing made from a resin and having one housing end which accommodates and retains the joint terminal with the tab pieces oriented toward another housing end, other housing end in which female terminal accommodation holes that fit the tab pieces into the respective pieces of the female terminal fittings by inserting the female terminal fittings up to a specified position are arranged in line within a horizontal plane orthogonal to a longitudinal direction, and lances for retaining the female terminal fittings inserted to the specified positions in the respective female terminal accommodation holes;
wherein the lances are provided for the respective terminal accommodation holes, and all of the lances are integrally joined together by a horizontally-stretched connecting member; and
the connecting member is provided with an operation section that integrally bends the lances in a direction in which removal of the female terminal fittings is prevented by operation of the connecting member.

2. The joint connector according to claim 1, wherein the operation section is provided at respective lateral ends of the connecting member, and the lateral operation section protrudes outward from both lateral ends of a main body of the connector housing.

3. An assembly jig for connector used when female terminal fittings is attached to the connector housing according to claim 2 comprising:
an insert recess used for insertion of the connector housing; and
an engagement section provided in a periphery of the insert recess and that interferes with the lateral operation sections of the connecting member when the connector housing is inserted into the insert recess, so as to operate the connecting member and bending all of the lances in a direction in which removal of the pieces of female terminal fitting is avoided.
